(19) United States
(12) Patent Application Publication
(10) Pub. No.: US 2025/0348235 A1
(43) Pub. Date: Nov. 13, 2025

(54) SLICE-BASED MEMORY CHANNEL POWER CONTROL

(71) Applicant: QUALCOMM Incorporated, San Diego, CA (US)

(72) Inventors: Mohsin Riaz, San Marcos, CA (US); Dhruvir Gandhi, San Diego, CA (US); Christophe Avoinne, San Diego, CA (US); Isaac Berk, San Diego, CA (US); Xavier Loic Leloup, San Diego, CA (US); Mosaddiq Saifuddin, San Diego, CA (US)

(21) Appl. No.: 18/659,266

(22) Filed: May 9, 2024

(51) Int. Cl. G06F 3/06

(52) U.S. Cl. CPC G06F 3/0625; G06F 3/0634; G06F 3/0673

(57) ABSTRACT

An apparatus includes a plurality of memory channels to a memory. The plurality of memory channels include a first slice and at least a second slice that is distinct from the first slice. The apparatus further includes power control circuitry coupled to the plurality of memory channels. The power control circuitry is configured to adjust, in accordance with a power collapse trigger condition associated with the first slice, operation of the first slice from a first mode of operation to a second mode of operation independently of the second slice. The first mode of operation is associated with a first power consumption level that is greater than a second power consumption level associated with the second mode of operation.

### TECHNICAL FIELD

Aspects relate generally to computer information systems, and more particularly, to memory systems for storing data.

### DESCRIPTION OF THE RELATED TECHNOLOGY

A computing device (e.g., a laptop, a mobile phone, etc.) may include one or several processors to perform various computing functions, such as telephony, wireless data access, and camera/video function, etc. A memory system may be an important component of the computing device. The processors may be coupled to the memory system to perform the computing functions. For example, the processors may fetch instructions from the memory system to perform the computing functions. The processors may also use the memory system to store data involved in performing these computing functions.

Memory systems include volatile memories and non-volatile memories. Non-volatile memories may retain stored information after a power-down event, and volatile memories may lose stored information after a power-down event. As a result, volatile memories may need to be “refreshed” to retain data during operation, which may consume power.

As memory systems are increasingly deployed in a wide variety of devices, the memory systems should exhibit scalability and flexibility. For example, as memory systems are deployed in automotive, artificial intelligence, and other applications, memory systems may be subject to increasingly large workloads. In some circumstances, such large workloads may require a large bandwidth and may incur a large amount of power consumption, which may reduce performance and may limit scalability.

### SUMMARY

In some aspects of the disclosure, an apparatus includes a plurality of memory channels to a memory. The plurality of memory channels include a first slice and at least a second slice that is distinct from the first slice. The apparatus further includes power control circuitry coupled to the plurality of memory channels. The power control circuitry is configured to adjust, in accordance with a power collapse trigger condition associated with the first slice, operation of the first slice from a first mode of operation to a second mode of operation independently of the second slice. The first mode of operation is associated with a first power consumption level that is greater than a second power consumption level associated with the second mode of operation.

In some additional aspects, a method includes accessing a memory using a plurality of memory channels. The plurality of memory channels include a first slice and at least a second slice that is distinct from the first slice. The method further includes, in accordance with a power collapse trigger condition associated with the first slice, adjusting operation of the first slice from a first mode of operation to a second mode of operation independently of the second slice. The first mode of operation is associated with a first power consumption level that is greater than a second power consumption level associated with the second mode of operation.

In some other aspects, a non-transitory computer-readable medium stores instructions executable by one or more processors to initiate, perform, or control operations. The operations include accessing a memory using a plurality of memory channels. The plurality of memory channels include a first slice and at least a second slice that is distinct from the first slice. The operations further include, in accordance with a power collapse trigger condition associated with the first slice, adjusting operation of the first slice from a first mode of operation to a second mode of operation independently of the second slice. The first mode of operation is associated with a first power consumption level that is greater than a second power consumption level associated with the second mode of operation

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows a block diagram of an example computing system incorporating a host, memory system, and channels coupling the host and the memory system according to one or more aspects of the disclosure.

FIG. 2 shows a block diagram of an example computing system incorporating a host, memory system, and channels coupling the host and the memory system with another implementation of the channels according to one or more aspects of the disclosure.

FIG. 3A and FIG. 3B illustrate waveforms of transfer of data through an example channel in a write operation in accordance with certain aspects of the present disclosure.

FIG. 4A and FIG. 4B illustrate waveforms for transfer of data through an example channel in a read operation in accordance with certain aspects of the present disclosure.

FIG. 5 illustrates an example of a system that supports slice-based memory channel power control in accordance with some aspects of the disclosure.

FIG. 6 illustrates an example of a slice of memory channels that may be included in the system of FIG. 5 in accordance with some aspects of the disclosure.

FIG. 7 illustrates a flow chart of an example of a method that supports slice-based memory channel power control in accordance with some aspects of the disclosure Like reference numbers and designations in the various drawings indicate like elements.

### DETAILED DESCRIPTION

In some aspects, memory channels to a memory may be grouped into slices, and each slice may be selectively power collapsed to reduce power consumption associated with operation of the memory channels. Grouping memory channels into slices may enable dynamic adjustment of an amount (or granularity) of components subject to a power collapse event, which may increase memory flexibility and scalability.

To illustrate, in some implementations, the memory channels may be associated with a bandwidth that supports a “peak” amount of memory access operations or data transfer. In some circumstances, the full bandwidth may be unnecessary, such as during a period of low access to the memory. In such examples, one or more slices may be power collapsed. Power collapsing a slice may include, for example, power-gating the slice to gate off power to one or more components of the slice, such as one or more channel-specific infrastructure components, one or more system level cache (SLC) controllers, one or more memory controllers, one or more physical interfaces to the memory, or one or more low power mode (LPM) components, as illustrative examples.

By selectively power collapsing slices of memory channels to a memory, bandwidth associated with the memory may be “tailored” based on a particular operating condition. As a non-limiting illustrative example, if a particular operating condition is to utilize approximately half of the bandwidth to the memory, half of the slices may be power collapsed in some examples, resulting in an effective bandwidth (or partial bandwidth) of approximately one-half of the full bandwidth. Other examples of partial bandwidths may also be used. As a result, power consumption may be reduced while also enabling a relatively large amount of bandwidth in some circumstances, such as for a “peak” amount of memory access operations or data transfer associated with the memory.

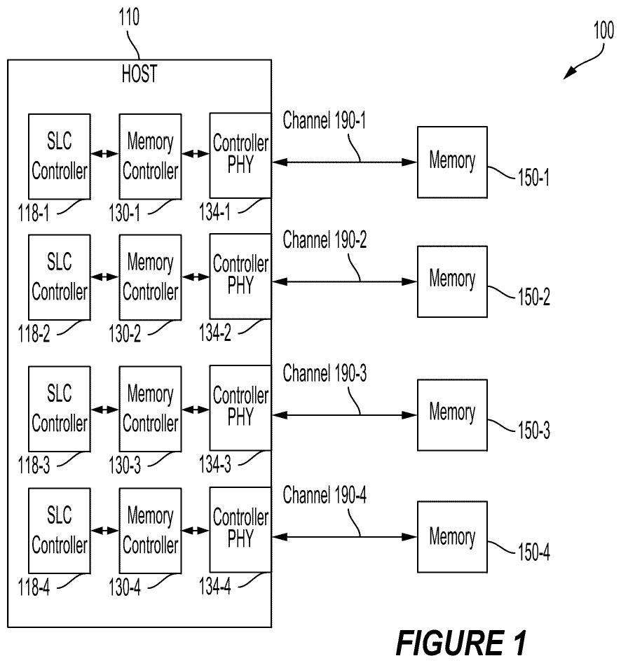

To further illustrate, an example memory device that may incorporate aspects of this disclosure, including slice-based memory channel power control, is shown in FIG. 1. FIG. 1 illustrates a system 100 incorporating a host 110, memories 150, and channels 190 coupling the host 110 and the memories 150. The system 100 may be, for example, a device among computing systems (e.g., servers, datacenters, desktop computers), mobile computing device (e.g., laptops, cell phones, vehicles, etc.), Internet of Things devices, virtual reality (VR) systems, augmented reality (AR) systems, automobile systems (e.g., driver assistance systems, autonomous driving systems), image capture devices (e.g., stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities), and/or multimedia systems (e.g., televisions, disc players, streaming devices, and other devices).

The host 110 may include one or more processors, such as central processing unit (CPU), graphic processing unit (GPU), digital signal processor (DSP), multimedia engine, and/or neural processing unit (NPU). The host 110 may be configured to couple and to communicate to the memories 150 (e.g., memories 150-1 to 150-4), via channels 190 (e.g., channels 190-1 to 190-4), in performing the computing functions, such as one of data processing, data communication, graphic display, camera, AR or VR rendering, image processing, neural processing, etc. For example, the memories 150-1 to 150-4 may store instructions or data for the host to perform the computing functions.

The host 110 may include system level cache (SLC) controllers 118-1 to 118-4, memory controllers 130-1 to 130-4, and controller PHY modules 134-1 to 134-4. Each of the controller PHY modules 134-1 to 134-4 may be coupled to a respective one of the memories 150-1 to 150-4 via respective channels 190-1 to 190-4. Further, each of the controller PHY modules 134-1 to 134-4 may be coupled to a respective one of the memory controllers 130-1 to 130-4, and each of the memory controllers 130-1 to 130-4 may be coupled to a respective one of the SLC controllers 118-1 to 118-4.

For case of reference, read and write are referenced from a perspective of the host 110. For example, in a read operation, the host 110 may receive via one or more of the channels 190-1-190-4 data stored from one or more of the memories 150-1 to 150-4. In a write operation, the host 110 may provide via one or more of the channels 190-1-190-4 data to be written into one or more of the memories 150-1-150-4 for storage. The SLC controllers 118-1 to 118-4 and the memory controllers 130-1 to 130-4 may be configured to control various aspects, such as logic layers, of communications to and from the memories 150-1-150-4, respectively. The controller PHY modules 134-1 to 134-4 may be configured to control electrical characteristics (e.g., voltage levels, phase, delays, frequencies, etc.) of signals provided or received on the channels 190-1-190-4, respectively.

In some examples, the memories 150-1-150-4 may be LPDDR DRAM (e.g., LPDDR5, LPDDR6). In some examples, the memories 150-1-150-4 may be different kinds of memory, such as one LPDDR5, one LPDDR6, one Flash memory, and one SRAM, respectively. The host 110, the memories 150-1-150-4, and/or the channels 190-1-190-4 may operate according to an LPDDR (e.g., LPDDR5, LPDDR6) specification. In some examples, each of the channels 190-1-190-4 may include 16 bits of data (e.g., 16 DQs). In some examples, each of the channels 190-1-190-4 may operate on 32 bits of data (e.g., 32 DQs). In FIG. 1, four channels are shown, however the system 100 may include more or less channels, such as 8 or 16 channels.

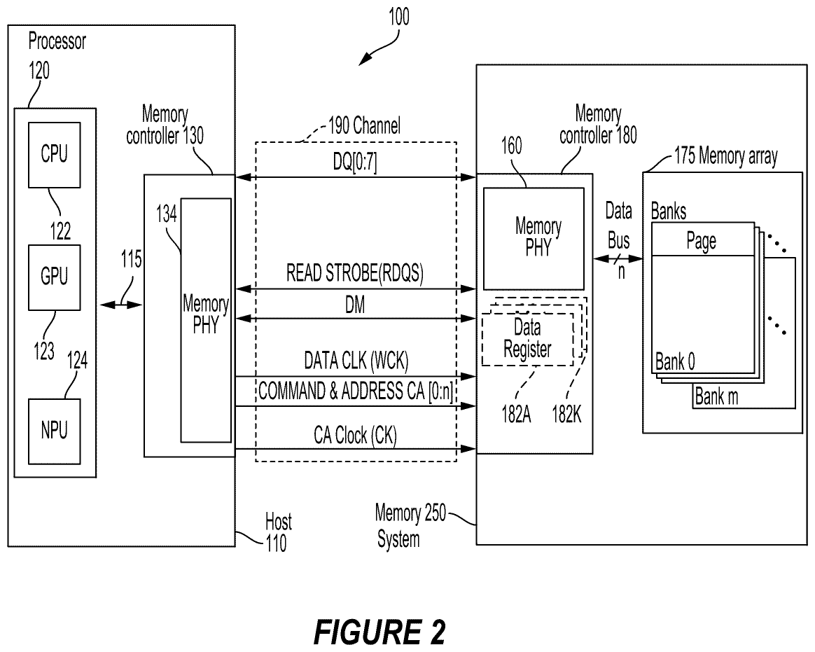

Additional details of an aspect of the embodiment of the system 100 for providing access to a memory system (such as one of memories 150-1-150-4 including logic and control circuit) are shown in FIG. 2. FIG. 2 illustrates a configuration of the host 110, a memory system 250, and the channel 190 of FIG. 1. The channel 190 between host 110 and the memory system 250 may include a plurality of connections, some of which carry data (e.g., user data or application data) and some of which carry non-data (e.g., addresses and other signaling information). For example, non-data connections in channel 190 may include a data clock (e.g., WCK) used in providing data to the respective memory system 250 and a read data strobe (e.g., RDQS) used in receiving data from the respective memory system 250, on a per byte basis. The channel 190 may further include a data mask (e.g., DM, sometimes referred to as data mask inversion DMI to indicate multiple functions performed by the signal connection) signaling used to mask certain part of data in a write operation. The channel 190 may further include command and address (e.g., CA[0:n]) and associated CA clock to provide commands (e.g., read or write commands) to the memory system 250.

The host 110 may include at least one processor 120, which may include a CPU 122, a GPU 123, and/or an NPU 124. The host 110 may further include a memory controller 130 having a controller PHY module 134. The memory controller 130 may couple to the at least one processor 120 via a bus system 115 in performing the various computing functions. The term “bus system” may provide that elements coupled to the “bus system” may exchange information therebetween, directly or indirectly. In different embodiments, the “bus system” may encompass multiple physical connections as well as intervening stages such as buffers, latches, registers, etc. A module may be implemented in hardware, software, or a combination of hardware and software.

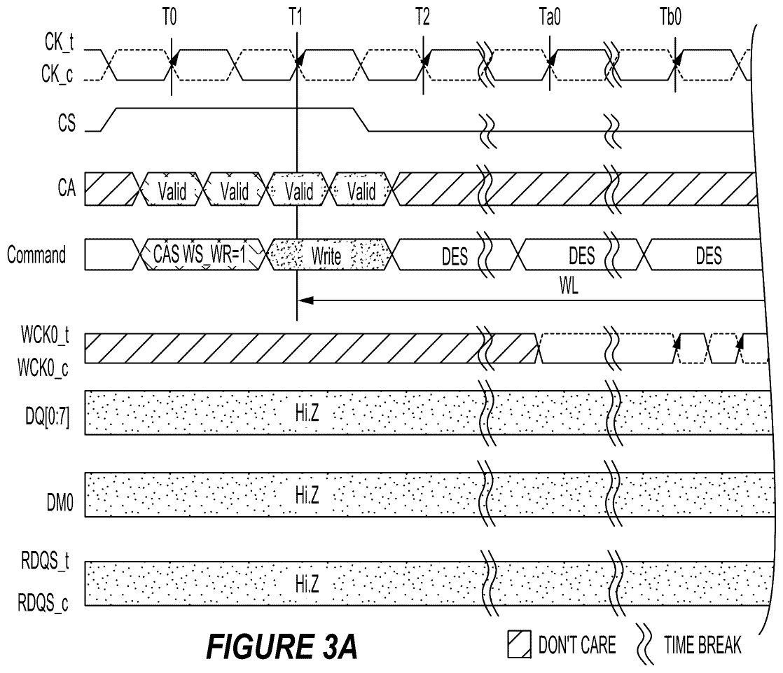

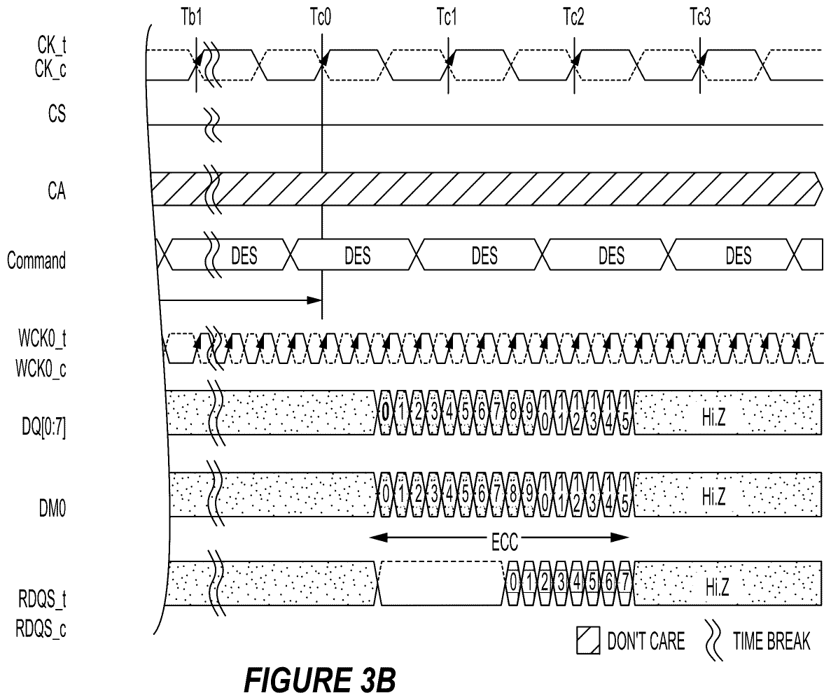

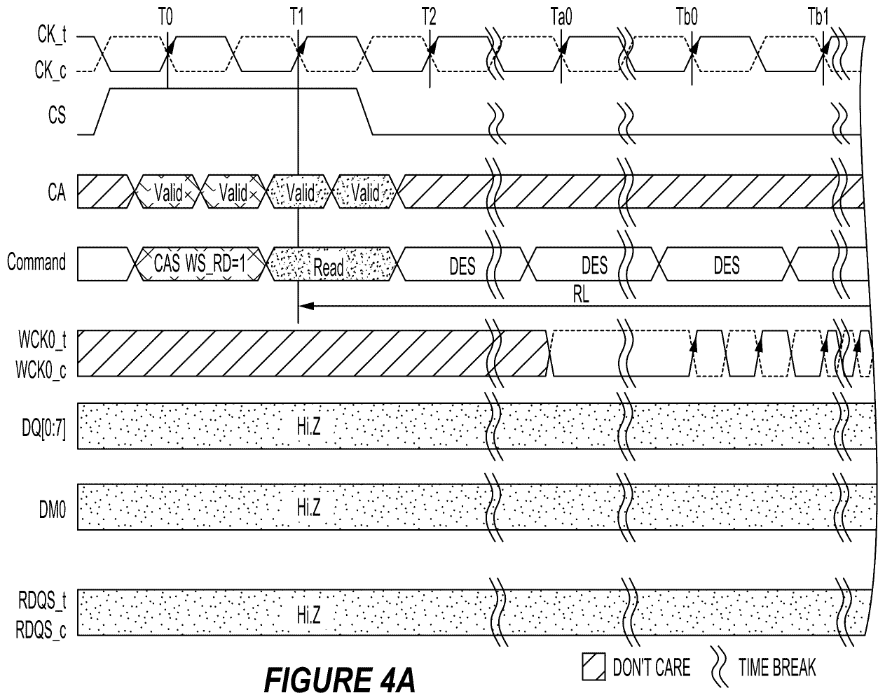

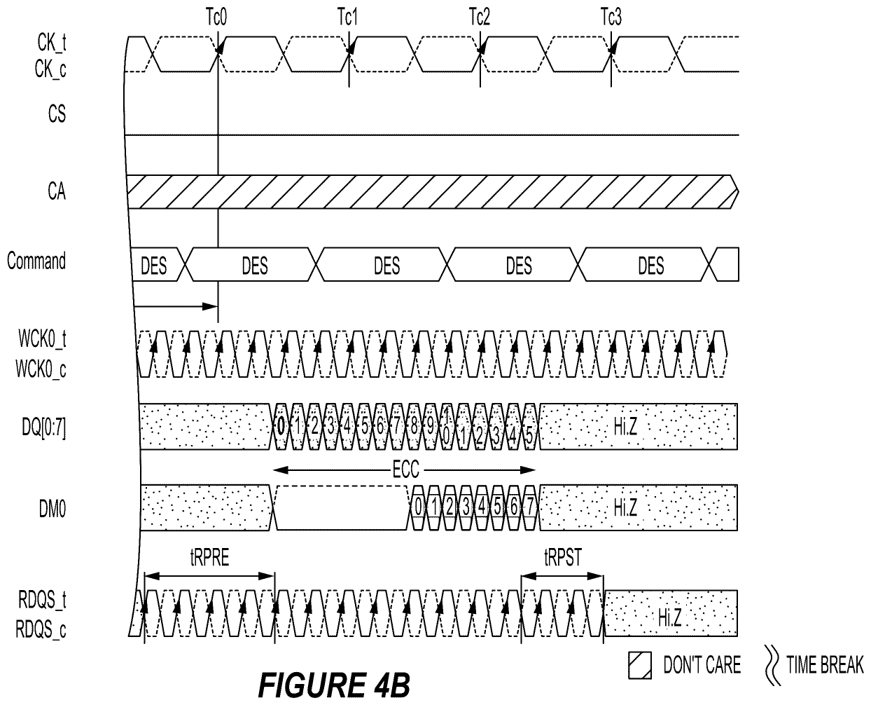

The memory controller 130 may send and/or receive blocks of data to other modules, such as the at least one processor 120 and/or the memory system 250. The memory system 250 may include a memory controller 180 with a memory I/O module 160 (e.g., a PHY layer) configured to control electrical characteristics (e.g., voltage levels, phase, delays, frequencies, etc.) to provide or to receive signals on connections of the channel 190. For example, memory I/O module 160 may be configured to capture (e.g., to sample) data, commands, and addresses from the host 110 via the channel 190 and to output data to the host 110 via the channel 190. Example techniques for communicating on the channel 190 between the memory I/O module 160 and the memory controller 130 are shown in the examples of FIG. 3A, FIG. 3B, FIG. 4A, and FIG. 4B. The memory controller 180 may also include data registers 182A-K configured to store data in transit between the host 110 and the memory array 175 and/or to store configuration settings or other data.

The memory system 250 may further include a memory array 175, which may include multiple memory cells (e.g., DRAM memory cells, MRAM memory cells, SRAM memory cells, or flash memory cells) that store values. The host 110 may read data stored in the memory array 175 and write data into the memory array 175, via the channel 190 and the memory I/O module 160. The memory array 175 may be divided into a plurality of banks with each bank organized as a plurality of pages.

Application or user data may be processed by the processor 120 and the memory controller 130 instructed to store and/or retrieve such data from the memory system 250. For example, data may be generated during the execution of an application, such as a spreadsheet program that computes values based on other data. As another example, data may be generated during the execution of an application by receiving user input to, for example, a spreadsheet program. As a further example, data may be generated during the execution of a gaming application, which generates information regarding a representation of a scene rendered by a three-dimensional (3-D) application.

The host 110 is coupled to the memory system 250 via the channel 190, which is illustrated for a byte of data, DQ[0:7]. The channel 190 and signaling between the host 110 and the memory system 250 may be implemented in accordance with the JEDEC DRAM specification (e.g., LPDDR5, LPDDR6). As illustrated, the channel 190 includes signal connections of the DQs, a read data strobe (RDQS), a data mask (DM), a data clock (WCK), command and address (CA[0: n]), and command and address clock (CK). The host 110 may use the read data strobe RDQS to strobe (e.g., to clock) data in a read operation to receive the data on the DQs. The memory system 250 may use the data mask DM to mask certain parts of the data from being written in a write operation. The memory system 250 may use the data clock WCK to sample data on the DQs for a write operation. The memory system 250 may use the command and address clock CK to clock (e.g., to receive) the CAs. A signal connection for each of the signaling may include a pin at the host 110, a pin at the memory system 250, and a conductive trace or traces electrically connecting the pins. The conductive trace or traces may be part of a single integrated circuit (IC) on a silicon chip containing the processor 120 and the memory system 250, may be part of a package on package (POP) containing the processor 120 and the memory system 250, or may be part of a printed circuit board (PCB) coupled to both the processor 120 and the memory system 250.

The memory system 250 may include a memory I/O module 160 (e.g., a PHY layer) configured to control electrical characteristics (e.g., voltage levels, phase, delays, frequencies, etc.) to provide or to receive signals on the channel 190. For example, memory I/O module 160 may be configured to capture (e.g., to sample) data, commands, and addresses from the host 110 via the channel 190 and to output data to the host 110 via the channel 190. Information transmitted across the channel 190 may be stored in registers in the memory I/O module 160 of the memory system 250 as a temporary or short-term storage location prior to longer-term storage in the memory array 175.

The memory system 250 may further include a memory array 175, which may include multiple memory cells (e.g., DRAM memory cells) that store information. The host 110 may read data stored in the memory array 175 and write data into the memory array 175 via the channel 190. Moreover, the memory array 175 may be configured to store metadata such as ECCs (e.g., system or array ECCs) associated with the stored data.

Operations according to some embodiments of this disclosure for storing and retrieving information from memory array 175 may be performed by controlling signals on individual lines of the channel 190. Example embodiments of signaling for a write operation are shown and described with reference to FIG. 3A and FIG. 3B. Example embodiments of signaling for a read operation are shown and described with reference to FIG. 4A and FIG. 4B.

FIG. 3A and FIG. 3B illustrate waveforms of transfer of data through an example channel in a write operation in accordance with certain aspects of the present disclosure. The command and address clock, CK, may be a differential signal having CK_t and CK_c signal connections. The data clock WCK may be a differential signal having WCK0_t and WCK0_c signal connections. The read data strobe RDQS may be a differential signal having RDQS_t and RDQS_c signal connections. The data mask is labeled DMO to indicate that DMO corresponds to a lower byte of DQs (DQ[0:7]). At TO (rising edge of CK_t and falling edge of CK_c), a CAS command may be provided by the host 110 for a write operation to the memory system 250. At T1, a write command may be provided by the host 110 to the memory system 250.

After a time period write latency (WL), the host 110 may toggle the data clock WCK0_t and WCK0_c to provide the memory system 250 with clocking for receiving data for write, on the DQ signal connections. At Tc0-Tc2, the memory system 250 may receive 16 bytes of data serially, on each of the DQ[0:7] signal connections and clocked by the data clock WCK0_t and WCK0_c. The memory system 250 may receive 16 bits of the data mask DMO serially (e.g., based on the data clock WCK0_t and WCK0_c) to mask certain portions of the received data from the write operation. In some examples, the 16 bytes of data and 16 bits of the data mask DMO may be received by the memory system 250, with each bit of the data mask DMO masking a corresponding byte of the received data. At Tc0-Tc2, the RDQS_t signal connection may be a Hi-Z condition. In a read operation, the RDQS_t signal connection may be configured to provide a read data strobe (RDQS) from the memory system 250 to the host 110

FIG. 4A and FIG. 4B illustrate waveforms for transfer of data through an example channel in a read operation in accordance with certain aspects of the present disclosure. The command and address clock, CK, may be a differential signal having CK_t and CK_c signal connections. The data clock WCK may be a differential signal having WCK0_t and WCK0_c signal connections. The read data strobe RDQS may be a differential signal having RDQS_t and RDQS_c signal connections. The data mask is labeled DMO to indicate that DMO corresponds to a lower byte of DQs (DQ[0:7]). At TO (rising edge of CK_t and falling edge of CK_c), a CAS command may be provided by the host 110 for a read operation to the memory system 250. At T1, a read command may be provided by the host 110 to the memory system 250.

After a time period read latency (RL), the memory system 250 may toggle the read data strobe RDQS to provide the host 110 with clocking to receive data for the read operation on the DQ signal connections. At Tc0-Tc2, the host 110 may receive 16 bytes of data serially, on each of the DQ[0:7] signal connections and clocked by the read data strobe RDQS_t and RDQS_c. Thus, in the example, 16 bytes of data are received by the host 110.

At Tc0-Tc2, the data mask DMO signal connection may be in a Hi-Z condition. In a write operation, the DM signal connection may be configured to provide a data mask from the host 110 to the memory system 250, which is clocked by WCK0_t and WCK0_c.

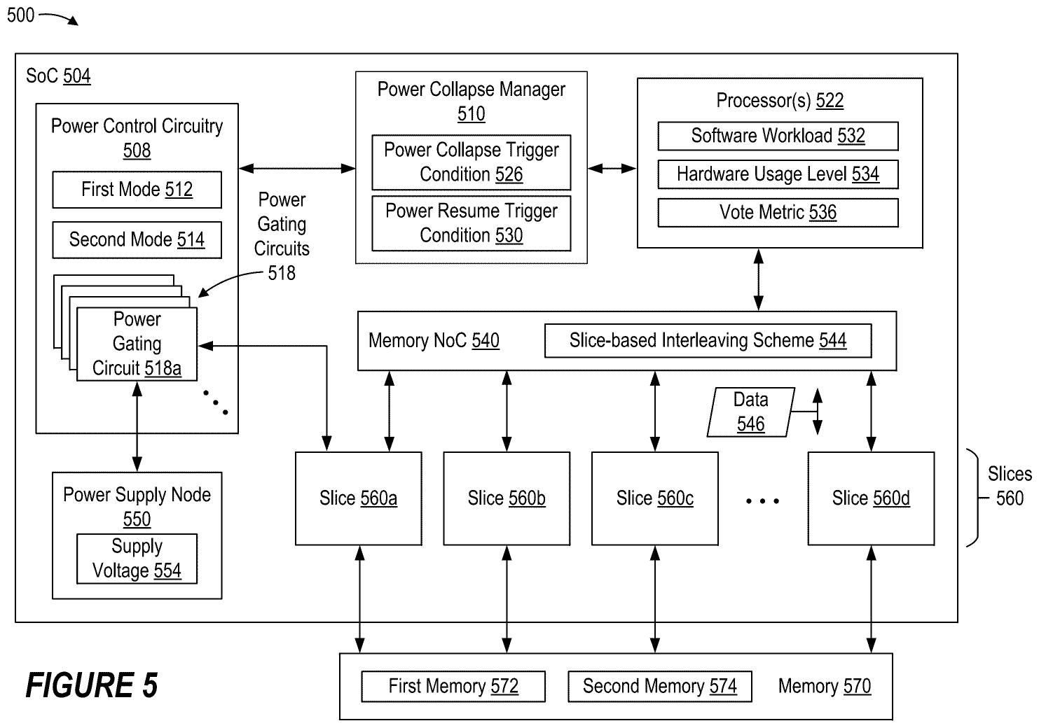

A memory system according to any of the aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, or avionics systems. In some aspects, one or more features described herein may be implemented using a system-on-chip (SoC) device, such as described further with reference to FIG. 5.

FIG. 5 illustrates an example of a system 500 that supports slice-based memory channel power control in accordance with some aspects of the disclosure. The system 500 may include a system-on-chip (SoC) 504 coupled to one or more memories, such as a memory 570. To illustrate, in some examples, the SoC 504 may correspond to or may be included in the host 110 of FIGS. 1 and 2. In some examples, the memory 570 may include any of the memories 150 of FIG. 1 or the memory system 250 of FIG. 2.

The SoC 504 may include power control circuitry 508, a power collapse manager 510, one or more processors 522, a memory network-on-chip (NoC) 540, and one or more power supply nodes, such as a power supply node 550. The one or more processors 522 may be coupled to the power collapse manager 510 and to the memory NoC 540. The power collapse manager 510 may be coupled to the power control circuitry 508. The memory NoC 540 may be coupled to the one or more processors 522. Depending on the implementation, the SoC 504 may correspond to a single-die SoC that includes a single semiconductor die or a multi-die SOC that includes multiple semiconductor dies.

In some implementations, the memory 570 may include a volatile memory, such as a dynamic random access memory (DRAM) or another type of memory. Other examples are also within the scope of the disclosure. For example, some features described herein may be used in connection with a non-volatile memory, such as a non-volatile random-access memory (NVRAM). In some implementations, the memory 570 may correspond to a hybrid memory that includes multiple types of memories, as described further below.

The system 500 may further include memory channels to the memory 570. The memory channels may enable access operations to the memory 570, such as read operations and write operations. In some implementations, the memory channels may include double date rate (DDR) channels to the memory 570. In some examples, the memory channels may include the channels 190 of FIG. 1. In some aspects, the memory channels may be grouped into slices 560, such as a slice 560a, a slice 560b, a slice 560c, and a slice 560d. Each slice of the slices 560 may include one or more memory channels. Further, although the example of FIG. 5 illustrates four slices, in other examples, the SoC 504 may include a different quantity of slices, such as fewer than four slices or more than four slices. A slice may also be referred to as, or may correspond to, a subset of memory channels.

In some implementations, the power control circuitry 508 may include power gating circuits 518, where each power gating circuit of the power gating circuits 518 is coupled to the power supply node 550 and to a respective slice of the slices 560. For example, the power control circuitry 508 may include a power gating circuit 518a coupled to the power supply node 550 and to the slice 560a. Further, other instances of power gating circuits of the power gating circuits 518 may be respectively coupled to the slices 560b-d (though such connections are omitted from FIG. 5 for clarity).

During operation, the one or more processors 522 may access the memory 570 using the memory NoC 540 and the slices 560. For example, the one or more processors 522 may perform write operations to write data 546 to the memory 570 using one or more of the slices 560, read operations to read the data 546 from the memory 570 using one or more of the slices 560, other operations, or a combination thereof. Further, the slices 560 may operate based on a first mode 512. In some examples, the first mode 512 may correspond to an active mode of operation. For example, during operation of the slice 560a based on the first mode 512, the power control circuitry 508 may connect the slice 560a to the power supply node 550 (e.g., via the power gating circuit 518a) in order to provide a supply voltage 554 to the slice 560a.

The first mode 512 may be associated with a first power consumption level. For example, during operation of a slice based on the first mode 512, the slice may consume a first amount of Watts (W) corresponding to the first power consumption level.

In some examples, the power control circuitry 508 may transition one or more of the slices 560 from the first mode 512 to a second mode 514. Transitioning a slice from the first mode 512 to the second mode 514 may be referred to as, or may include, a power collapse event or deactivation of the slice. In some examples, the second mode 514 may correspond to an inactive mode operation. For example, during operation of the slice 560a based on the second mode 514, the power control circuitry 508 may disconnect the slice 560a from the power supply node 550 (e.g., via the power gating circuit 518a) to cease to provide the supply voltage 554 to the slice 560a. In an example, the memory channels of the SoC 504 may be coupled to the power supply node 550, and the power control circuitry 508 may include, for each slice 560 of the memory channels, a power gating circuit 518 that is coupled to the power supply node 550 and that is configured to selectively disconnect the slice from the power supply node 550.

The second mode 514 may be associated with a second power consumption level that is less than the first power consumption level associated with the first mode 512. For example, during operation of a slice based on the second mode 514, the slice may consume a second amount of Watts (W) corresponding to the second power consumption level, where the second amount is less than the first amount associated with the first mode 512.

To further illustrate, in some implementations, one or more of the power gating circuits 518 may include a switch and a selection circuit coupled to the switch. In an example, the selection circuit may include a p-type metal-oxide-semiconductor (PMOS) transistor, and the selection circuit may include a multiplexer (MUX) coupled to a gate of the PMOS transistor. The one or more processors 522 may provide an enable signal to the MUX to cause the MUX to output a control signal to activate the switch (e.g., to enable the first mode 512) or to deactivate the switch (e.g., to enable the second mode 514). Other examples are also within the scope of the disclosure.

Further, the power control circuitry 508 may adjust operation of each slice of the slices 560 independently other slices of the slices 560. To illustrate, while the slice 560a operates according to the second mode 514, the slices 560b-d may each operate according to either the first mode 512 or the second mode 514. Accordingly, each of the slices 560 may be individually configurable to operate based on either the first mode 512 or the second mode 514.

In some examples, operation of a slice may be adjusted from the first mode 512 to the second mode 514 based on a power collapse trigger condition 526 associated with the slice. For example, based on detecting the power collapse trigger condition 526 associated with the slice 560a, the one or more processors 522 may cause the power control circuitry 508 to transition the slice 560a from the first mode 512 to the second mode 514 (e.g., by causing the power gating circuit 518a to disconnect the slice 560a from the supply voltage 554). Depending on the implementation, the power collapse trigger condition 526 may include one or more hardware states associated with the system 500, one or more software states associated with the system 500, one or more other states or conditions, or a combination thereof.

To illustrate, in some implementations, the power collapse trigger condition 526 may be based on a software workload 532 of a processor of one or more processors 522, where the processor is associated with the slice 560 (e.g., where the processor accesses the memory 570 using the slice 560a). The software workload 532 may indicate, for example, a quantity of instructions per second that are executed by the processor, or another metric. If the software workload 532 fails to exceed a threshold workload (such as if the quantity of instructions per second fails to exceed a threshold quantity of instructions per second), the processor may provide (e.g., to the power collapse manager 510) feedback associated with the power collapse trigger condition 526 for the slice 560a. In some examples, if the power collapse trigger condition 526 is satisfied, the power collapse manager 510 may instruct the power control circuitry 508 to transition the slice 560a from the first mode 512 to the second mode 514.

Alternatively, or in addition, in some implementations, the power collapse trigger condition 526 may be based on a hardware usage level 534 associated with the slice 560a. For example, the hardware usage level 534 may indicate an amount of traffic carried by the slice 560a. In some examples, the amount of traffic may be measured or indicated in data per unit of time, such as packets per second or bytes per second. If the hardware usage level 534 fails to exceed a threshold usage level (such as if an amount of packets per second or bytes per second fails to exceed a threshold amount of packets per second or bytes per second), the processor may provide (e.g., to the power collapse manager 510) feedback associated with the power collapse trigger condition 526 for the slice 560a. In some examples, if the power collapse trigger condition 526 is satisfied, the power collapse manager 510 may instruct the power control circuitry 508 to transition the slice 560a from the first mode 512 to the second mode 514.

Alternatively, or in addition, in some implementations, the power collapse trigger condition 526 may be based on a vote metric 536 associated with the one or more processors 522. For example, each processor of the one or more processors 522 may output a respective vote signal having either a first value indicating a request to operate the slice 560a in the first mode 512 or a second value indicating a request to operate the slice 560a in the second mode 514. In an example implementation in which the one or more processors 522 include one processor, then such a vote signal may be provided to the power collapse manager 510 as the vote metric 536. In an example implementation in which the one or more processors 522 include multiple processors, then multiple such vote signals may be provided to a logic circuit (e.g., an AND gate) associated with the slice 560a. In some implementations, the logic circuit may be included in or may correspond to the power collapse manager 510. The logic circuit may output a combined vote signal to the power control circuitry 508 (e.g., to a selection circuit of the power gating circuit 518a) as the vote metric 536. In some examples, if each vote signal has a first value (such as a logic zero value), the combined vote signal may have a particular value (such as a logic zero value) indicating the second mode 514. In some other examples, if at least one vote signal has a second value (such as a logic one value), the combined vote signal may have another value (such as a logic one value) indicating the first mode 512. In some implementations, each slice 560 may be associated with a respective logic gate. A vote signal may also be referred to as a client tolerance vote. Further, a vote signal may be implemented using hardware, software, or a combination thereof.

In some cases, the one or more processors 522 may detect a power resume trigger condition 530. The power resume trigger condition 530 may be associated with a change of operation of a slice from the second mode 514 to the first mode 512. To illustrate, in some examples, detection of the power resume trigger condition 530 may include or may be based on detection of the software workload 532 satisfying a threshold (which may be the same as or different than the threshold associated with the power collapse trigger condition 526). Alternatively, or in addition, detection of the power resume trigger condition 530 may include or may be based on detection of data 546 that is scheduled or available to be written to or read from the memory 570. In one example, one or more of the memory NoC 540 or the memory 570 may include a buffer associated with each slice 560. Based on data being stored to the buffer, the one or more processors 522 may detect the power resume trigger condition 530. Alternatively, or in addition, detection of the power resume trigger condition 530 may include or may be based on the vote metric 536, such as if at least one vote signal from at least one processor 522 indicates the first mode 512.

In some implementations, the memory NoC 540 may operate in accordance with one or more interleaving schemes, which may improve load balancing or reduce or avoid bottlenecks associated with accessing the memory 570. For example, when writing the data 546 to the memory 570 or reading the data 546 from the memory 570, the memory NoC 540 may separate the data 546 into multiple subsets and may use multiple slices 560 to write the multiple subsets to the memory 570 or to read the multiple subsets from the memory 570. As an illustrative example, the memory NoC 540 may separate the data 546 into four subsets and may associate each of the slices 560a-d with a respective one of the four subsets. As a result, load balancing may be improved, such as by reducing or avoiding a bottleneck that may occur if one slice 560 is used to write or read the data 546 to the memory 570.

In some aspects, the memory NoC 540 may operate in accordance with a slice-based interleaving scheme 544. The slice-based interleaving scheme 544 may also be referred to as an intra-slice interleaving scheme. The slice-based interleaving scheme 544 may enable inter-slice interleaving or may disable inter-slice interleaving. To illustrate, the slice-based interleaving scheme 544 may enable intra-slice interleaving of memory access operations within a first slice (such as the slice 560a) and may disable inter-slice interleaving of the memory access operations between the first slice and a second slice (such as the slice 560b). The memory access operations may include a write operation to write the data 546 to the memory 570 or a read operation to read the data 546 from the memory 570. Depending on the implementation, the slice-based interleaving scheme 544 may be applied across a single die of the SoC 504 or across multiple dies of the SoC 504. By performing interleaving on a per-slice basis, the interleaving may be compatible with selective deactivation of slices using the power control circuitry 508. As a result, opportunities for power collapse may be increased, decreasing power consumption.

Although the memory 570 may be described as a single memory for illustration, other examples are also within the scope of the disclosure. For example, in some implementations, the memory 570 may include a hybrid memory including multiple different types of memories. To illustrate, in some examples, the memory 570 may include a first memory 572 of a first memory type and a second memory 574 of a second memory type different than the first memory type. To illustrate, in some examples, the first memory type may be one of a dynamic random access memory (DRAM) memory type or a static random access memory (SRAM) type, and the second memory type may be the other of the DRAM type of the SRAM type. Other examples are also within the scope of the disclosure. For example, in some implementations, the first memory type may be one of a volatile memory type or a non-volatile memory type, and the second memory type may be the other of the volatile memory type or the non-volatile memory type.

Further, in some examples, a slice 560 may be associated with a respective memory type, such as where each slice 560 is dedicated to writing data to and reading data from a respective memory type. For example, a first slice (such as the slice 560a) may be associated with the first memory 572, and a second slice (such as the slice 560b) may be associated with the second memory 574.

Alternatively or in addition to including a hybrid memory, in some implementations, the memory 570 may include a distributed memory. In some examples, such a distributed memory may include memories located at different physical locations. In some examples, the memories may be presented as a single memory using a virtualization scheme. To further illustrate, in an example, the first memory 572 may be located at a first physical location, and the second memory 574 may be located at a second physical location different than the first memory 572. In one example, the first location may correspond to a local physical location, such as where the first memory 572 is included in a common product or device as the SoC 504, and the second location may correspond to a remote physical location, such as within a cloud storage system, as illustrative examples.

In some examples, the one or more processors 522 may selectively activate or deactivate the slices 560 based on applications executed by the one or more processors 522. To illustrate, in one example, an application may be associated with use of the first memory 572 but not the second memory 574. If slice 560a is associated with the first memory 572 and the slice 560b is associated with the second memory 574, the one or more processors 522 may transition the slice 560b to the second mode 514 based on loading the application for execution (while operating the slice 560a based on the first mode 512).

In some implementations, the one or more processors 522 may store control information indicating a mapping of applications to combinations of the slices 560 that are to be activated (or deactivated) during execution of the applications. For example, the control information may include a bitmask. Each row of the bitmask may correspond to a respective application of the applications, and each column of the bitmask may correspond to a respective slice of the slices 560. Each bit of the bitmask may have a value indicating whether the corresponding slice is to be activated or deactivated during execution of the corresponding application. For example, a logic one value (or a logic zero value) may indicate the corresponding slice is to be activated during execution of the corresponding application, and a logic zero value (or a logic one value) may indicate the corresponding slice is to be deactivated during execution of the corresponding application. Other examples are also within the scope of the disclosure. For example, in some implementations, the control information may indicate a mapping of applications to amounts of memory bandwidth associated with the applications, and the one or more processors 522 may selectively activate and deactivate the slices 560 to enable (or approximate) the different amounts of memory bandwidth.

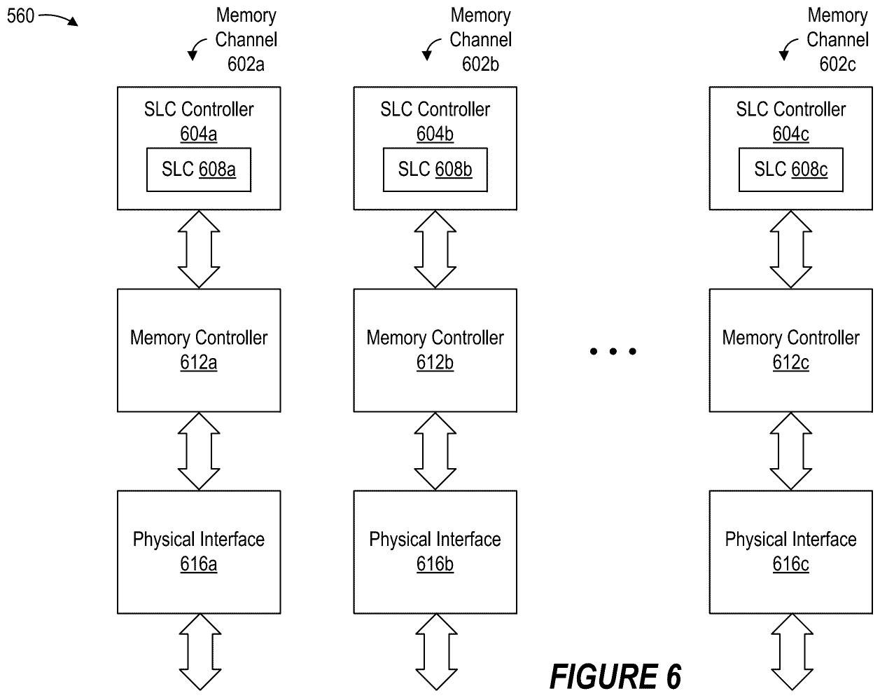

FIG. 6 illustrates an example of a slice 560 of memory channels that may be included in the system 500 of FIG. 5 in accordance with some aspects of the disclosure. For example, the slice 560 of FIG. 6 may correspond to any of the slices 560a-d of FIG. 5. The slice 560 may include one or more memory channels, such as a memory channel 602a, a memory channel 602b, and a memory channel 602c.

Each memory channel may include a system level cache (SLC) controller. For example, the memory channels 601a-c may include SLC controllers 604a-c, respectively. Further, each SLC controller may include an SLC. For example, the SLC controllers 604a-c may include SLCs 608a-c, respectively. In some examples, the SLC controllers 118-1 to 118-4 of FIG. 1 may include or correspond to the SLC controllers 604a-c of FIG. 6.

Each memory channel may further include a memory controller. For example, the memory channels 602a-c may include memory controllers 612a-c, respectively. Further, the memory controllers 612a-c may be coupled to the SLC controllers 604a-c, respectively. In some examples, the memory controllers 130-1 to 130-4 of FIG. 1 may include or correspond to the memory controllers 612a-c of FIG. 6.

Each memory channel may also include a physical interface between a memory controller and the memory 570 of FIG. 5. For example, the memory channels 602a-c may include physical interfaces 616a-c, respectively. The physical interfaces 616a-c may be coupled to the memory controllers 612a-c, respectively, and to the memory 570. In some examples, the controller PHY modules 134-1 to 134-4 of FIG. 1 may include or correspond to the physical interfaces 616a-c of FIG. 6.

Although the example of FIG. 6 illustrates some examples of components that may be included in a slice, other examples are also within the scope of the disclosure. To illustrate, in some implementations, a slice may include one or more channel-specific infrastructure components (such as a channel-specific memory NoC), one or more low power mode (LPM) components (such as a DRAM LPM component), or one or more other components (alternatively or in addition to the components illustrated in FIG. 6).

One or more features described herein may improve performance of an electronic device that includes a memory, such as the memory 570. For example, by selectively power collapsing the slices 560 of memory channels to the memory 570, bandwidth associated with the memory 570 may be “tailored” based on a particular operating condition. As a non-limiting illustrative example, if a particular operating condition is to utilize approximately half of the bandwidth to the memory 570, half of the slices 560 may be power collapsed in some examples, resulting in an effective bandwidth (or partial bandwidth) of approximately one-half of the full bandwidth. Other examples of partial bandwidths may also be used. As a result, power consumption may be reduced while also enabling a relatively large amount of bandwidth in some circumstances, such as for a “peak” amount of memory access operations or data transfer associated with the memory 570.

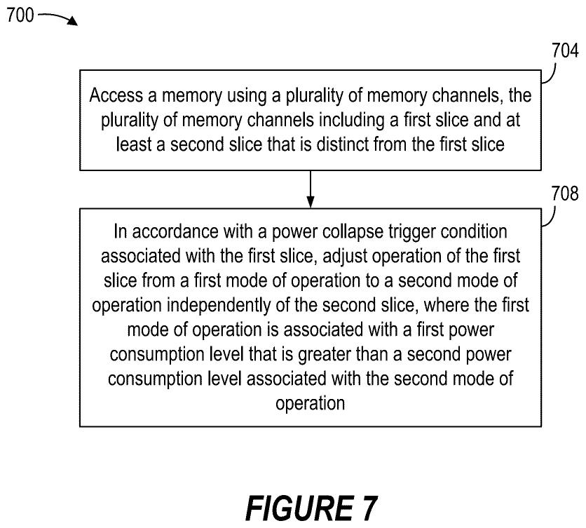

FIG. 7 illustrates a flow chart of an example of a method 700 that supports slice-based memory channel power control in accordance with some aspects of the disclosure. In some examples, operations of the method 700 may be initiated, performed, or controlled by one or more devices described herein, such as the system 100 of FIGS. 1 and 2, the host 110 of FIGS. 1 and 2, the system 500 of FIG. 5, or the SoC 504 of FIG. 5.

The method 700 includes accessing a memory using a plurality of memory channels, at 704. The plurality of memory channels include a first slice and at least a second slice that is distinct from the first slice. For example, the SoC 504 may access the memory 570 using a plurality of memory channels that may include or correspond to the slices 560. The slices 560 may include a first slice (such as one of the slices 560a-d) and a second sliced (such as another of the slices 560a-d) that is distinct from the first slice.

The method 700 further includes, in accordance with a power collapse trigger condition associated with the first slice, adjusting operation of the first slice from a first mode of operation to a second mode of operation independently of the second slice, at 708. The first mode of operation is associated with a first power consumption level that is greater than a second power consumption level associated with the second mode of operation. To illustrate, in accordance with the power collapse trigger condition 526 associated with the slice 560a (or another slice), the SoC 504 may adjust operation of the slice 560a from the first mode 512 to the second mode 514 independently of another slice (such as the slice 560b). During operation of the slice 560a based on the second mode 514, the slice 560a may consume less power as compared to operation of the slice 560a based on the first mode 512.

In a first aspect, an apparatus includes a plurality of memory channels to a memory. The plurality of memory channels include a first slice and at least a second slice that is distinct from the first slice. The apparatus further includes power control circuitry coupled to the plurality of memory channels. The power control circuitry is configured to adjust, in accordance with a power collapse trigger condition associated with the first slice, operation of the first slice from a first mode of operation to a second mode of operation independently of the second slice. The first mode of operation is associated with a first power consumption level that is greater than a second power consumption level associated with the second mode of operation.

In a second aspect, in combination with the first aspect, the power control circuitry is further configured to detect a power resume trigger condition associated with the first slice and to adjust, based on detecting the power resume trigger condition, operation of the first slice from the second mode to the first mode independently of the second slice.

In a third aspect, in combination with one or more of the first aspect or the second aspect, the first slice and the second slice each include a system level cache (SLC) controller, a memory controller coupled to the SLC controller, and a physical interface between the memory controller and the memory.

In a fourth aspect, in combination with one or more of the first aspect through the third aspect, the plurality of memory channels are coupled to one or more power supply nodes, and the power control circuitry includes, for each slice of the plurality of memory channels, a power gating circuit that is coupled to the one or more power supply nodes and that is configured to selectively disconnect the slice from the one or more power supply nodes.

In a fifth aspect, in combination with one or more of the first aspect through the fourth aspect, the apparatus further includes a power collapse manager that is coupled to the power control circuitry and that is configured to detect the power collapse trigger condition.

In a sixth aspect, in combination with one or more of the first aspect through the fifth aspect, the power collapse manager is further configured to detect the power collapse trigger condition based on one or more of a software workload of a processor that is associated with the first slice, a hardware usage level associated with the first slice, or a vote metric associated with one or more processors including the processor.

In a seventh aspect, in combination with one or more of the first aspect through the sixth aspect, the apparatus further includes a memory network-on-chip (NoC) coupled to the plurality of memory channels and to the memory, and the memory NoC is configured to operate in accordance with a slice-based interleaving scheme.

In an eighth aspect, in combination with one or more of the first aspect through the seventh aspect, the slice-based interleaving scheme enables an intra-slice interleaving of memory access operations within the first slice and disables an inter-slice interleaving of the memory access operations between the first slice and the second slice.

In a ninth aspect, in combination with one or more of the first aspect through the eighth aspect, the memory corresponds to a hybrid memory including a first memory of a first memory type and a second memory of a second memory type different than the first memory type, the first slice is associated with the first memory, and the second slice is associated with the second memory.

In a tenth aspect, a method includes accessing a memory using a plurality of memory channels. The plurality of memory channels include a first slice and at least a second slice that is distinct from the first slice. The method further includes, in accordance with a power collapse trigger condition associated with the first slice, adjusting operation of the first slice from a first mode of operation to a second mode of operation independently of the second slice. The first mode of operation is associated with a first power consumption level that is greater than a second power consumption level associated with the second mode of operation.

In an eleventh aspect, in combination with the tenth aspect, the method further includes detecting a power resume trigger condition associated with the first slice and, based on detecting the power resume trigger condition, adjusting operation of the first slice from the second mode to the first mode independently of the second slice.

In a twelfth aspect, in combination with one or more of the tenth aspect through the eleventh aspect, the first slice and the second slice each include a system level cache (SLC) controller, a memory controller coupled to the SLC controller, and a physical interface between the memory controller and the memory.

In a thirteenth aspect, in combination with one or more of the tenth aspect through the twelfth aspect, the method further includes, for each slice of the plurality of memory channels, selectively disconnecting the slice from one or more power supply nodes using power control circuitry.

In a fourteenth aspect, in combination with one or more of the tenth aspect through the thirteenth aspect, the method further includes detecting the power collapse trigger condition using a power collapse manager.

In a fifteenth aspect, in combination with one or more of the tenth aspect through the fourteenth aspect, the power collapse trigger condition is detected based on one or more of a software workload of a processor that is associated with the first slice, a hardware usage level associated with the first slice, or a vote metric associated with one or more processors including the processor.

In a sixteenth aspect, in combination with one or more of the tenth aspect through the fifteenth aspect, the memory is accessed via a memory network-on-chip (NoC) and in accordance with a slice-based interleaving scheme.

In a seventeenth aspect, in combination with one or more of the tenth aspect through the sixteenth aspect, the slice-based interleaving scheme enables an intra-slice interleaving of memory access operations within the first slice and disables an inter-slice interleaving of the memory access operations between the first slice and the second slice.

In an eighteenth aspect, in combination with one or more of the tenth aspect through the seventeenth aspect, the memory corresponds to a hybrid memory including a first memory of a first memory type and a second memory of a second memory type different than the first memory type, the first slice is associated with the first memory, and the second slice is associated with the second memory.

In a nineteenth aspect, a non-transitory computer-readable medium stores instructions executable by one or more processors to initiate, perform, or control operations. The operations include accessing a memory using a plurality of memory channels. The plurality of memory channels include a first slice and at least a second slice that is distinct from the first slice. The operations further include, in accordance with a power collapse trigger condition associated with the first slice, adjusting operation of the first slice from a first mode of operation to a second mode of operation independently of the second slice. The first mode of operation is associated with a first power consumption level that is greater than a second power consumption level associated with the second mode of operation

In a twentieth aspect, in combination with the nineteenth aspect, the operations further include detecting a power resume trigger condition associated with the first slice and, based on detecting the power resume trigger condition, adjusting operation of the first slice from the second mode to the first mode independently of the second slice.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus comprising:
a plurality of memory channels to a memory, the plurality of memory channels including a first slice and at least a second slice that is distinct from the first slice;
power control circuitry coupled to the plurality of memory channels and configured to adjust, in accordance with a power collapse trigger condition associated with the first slice, operation of the first slice from a first mode of operation to a second mode of operation independently of the second slice, wherein the first mode of operation is associated with a first power consumption level that is greater than a second power consumption level associated with the second mode of operation; and
circuitry coupled to the plurality of memory channels and configured to perform interleaving of memory access operations to the first slice and the second slice on a per-slice basis.

2. The apparatus of claim 1, wherein the power control circuitry is further configured to:
detect a power resume trigger condition associated with the first slice; and
based on detecting the power resume trigger condition, adjust operation of the first slice from the second mode to the first mode independently of the second slice.

3. The apparatus of claim 1, wherein the first slice and the second slice each include a system level cache (SLC) controller, a memory controller coupled to the SLC controller, and a physical interface between the memory controller and the memory.

4. The apparatus of claim 1, wherein the plurality of memory channels are coupled to one or more power supply nodes, and wherein the power control circuitry includes, for each slice of the plurality of memory channels, a power gating circuit that is coupled to the one or more power supply nodes and that is configured to selectively disconnect the slice from the one or more power supply nodes.

5. The apparatus of claim 1, further comprising a power collapse manager that is coupled to the power control circuitry and that is configured to detect the power collapse trigger condition.

6. The apparatus of claim 5, wherein the power collapse manager is further configured to detect the power collapse trigger condition based on one or more of a software workload of a processor that is associated with the first slice, a hardware usage level associated with the first slice, or a vote metric associated with one or more processors including the processor.

7. The apparatus of claim 1, wherein the circuitry includes a memory network-on-chip (NoC) coupled to the plurality of memory channels and to the memory, and wherein the memory NoC is configured to operate in accordance with a slice-based interleaving scheme.

8. The apparatus of claim 7, wherein the slice-based interleaving scheme enables an intra-slice interleaving of the memory access operations within the first slice and disables an inter-slice interleaving of the memory access operations between the first slice and the second slice.

9. The apparatus of claim 1, wherein the memory corresponds to a hybrid memory including a first memory of a first memory type and a second memory of a second memory type different than the first memory type, wherein the first slice is associated with the first memory, and wherein the second slice is associated with the second memory.

10. A method comprising:
accessing a memory using a plurality of memory channels, the plurality of memory channels including a first slice and at least a second slice that is distinct from the first slice, wherein accessing the memory includes performing interleaving of memory access operations to the first slice and the second slice on a per-slice basis; and
in accordance with a power collapse trigger condition associated with the first slice, adjusting operation of the first slice from a first mode of operation to a second mode of operation independently of the second slice,
wherein the first mode of operation is associated with a first power consumption level that is greater than a second power consumption level associated with the second mode of operation.

11. The method of claim 10, further comprising:
detecting a power resume trigger condition associated with the first slice; and
based on detecting the power resume trigger condition, adjusting operation of the first slice from the second mode to the first mode independently of the second slice.

12. The method of claim 10, wherein the first slice and the second slice each include a system level cache (SLC) controller, a memory controller coupled to the SLC controller, and a physical interface between the memory controller and the memory.

13. The method of claim 10, further comprising, for each slice of the plurality of memory channels, selectively disconnecting the slice from one or more power supply nodes using power control circuitry.

14. The method of claim 10, further comprising detecting the power collapse trigger condition using a power collapse manager.

15. The method of claim 14, wherein the power collapse trigger condition is detected based on one or more of a software workload of a processor that is associated with the first slice, a hardware usage level associated with the first slice, or a vote metric associated with one or more processors including the processor.

16. The method of claim 10, wherein the memory is accessed via a memory network-on-chip (NoC) and in accordance with a slice-based interleaving scheme.

17. The method of claim 16, wherein the slice-based interleaving scheme enables an intra-slice interleaving of the memory access operations within the first slice and disables an inter-slice interleaving of the memory access operations between the first slice and the second slice.

18. The method of claim 10, wherein the memory corresponds to a hybrid memory including a first memory of a first memory type and a second memory of a second memory type different than the first memory type, wherein the first slice is associated with the first memory, and wherein the second slice is associated with the second memory.

19. A non-transitory computer-readable medium storing instructions executable by one or more processors to initiate, perform, or control operations, the operations comprising:
accessing a memory using a plurality of memory channels, the plurality of memory channels including a first slice and at least a second slice that is distinct from the first slice wherein accessing the memory includes performing interleaving of memory access operations to the first slice and the second slice on a per-slice basis;
in accordance with a power collapse trigger condition associated with the first slice, adjusting operation of the first slice from a first mode of operation to a second mode of operation independently of the second slice,
wherein the first mode of operation is associated with a first power consumption level that is greater than a second power consumption level associated with the second mode of operation.

20. The non-transitory computer-readable medium of claim 19, wherein the operations further comprise:
detecting a power resume trigger condition associated with the first slice; and
based on detecting the power resume trigger condition, adjusting operation of the first slice from the second mode to the first mode independently of the second slice.
